(19) United States
(12) Patent Application Publication
(10) Pub. No.: US 2005/0011329 A1
(43) Pub. Date: Jan. 20, 2005

(54) Circular saw blade mounting assembly

(76) Inventor: Edward L. Briggs, Goose Lake, IA (US)

Correspondence Address: Charles W. Chandler, 33150 Schoolcraft, Livonia, MI, 48150, US

(21) Appl. No.: 10/619,156

(22) Filed: Jul. 14, 2003

(51) Int. Cl. B23D 45/00

(52) U.S. Cl. 83/666; 83/698.41

(57) ABSTRACT

A mounting structure for a circular saw blade uses a pair of washers for clamping the saw blade on a spindle. One washer has a saw blade clamping surface and a flange for passing the central hole of the saw blade. The saw blade opening has a complementary opening formed in such a manner that the saw blade can only be clamped on the spindle in which the cutting edges of the blade are facing in the correct direction of rotation.

### FIELD OF THE INVENTION

The present invention relates to a mounting structure for rotating saw cutting blades. More specifically, the invention relates to a specially configured pair of washers for mounting a saw blade on a spindle to prevent the cutting edges of the saw blade from being mismounted on the spindle.

### BACKGROUND AND SUMMARY OF THE INVENTION

There are many applications in which a circular saw blade has cutting edges that can be rotated in either direction. However, in some cases the saw blade edges are formed such that the saw blade can only be used with the saw blade rotating in one direction. Sometimes notices are provided on the saw blade as to which side is out in order to ensure correct orientation of the blade on the spindle.

Some prior art relating to various solutions to this problem include U.S. Pat. Nos. 5,373,834 issued Dec. 20, 1994, to Edward R. Chiuminatta and Alan R. Chiuminatta for “Mounting Arbor for Saw Cutting Blades”; and 5,799,558 issued Sep. 1, 1998, to Keith H. Hewitt et al., for “Arbor and Circular Saw with Asymmetric Spline Having Generally Radial Force-Transmitting Face”.

The broad purpose of the present invention is to provide an improved apparatus for mounting a circular unidirectional saw blade on a rotating spindle, so that the blade rotates in the proper direction. In the preferred embodiment, the saw blade is clamped between a pair of novel washers mounted on the spindle. An inner washer has an irregularly shaped flange over which the central opening of the saw blade must be passed to a clamping position. The saw blade has a central opening with a complementary shape to that of the flange inner washer so that the saw blade can only be mounted in a proper cutting position.

Still further objects and advantages of the invention will become readily apparent to those skilled in the art to which the invention pertains upon reference to the following detailed description.

### DESCRIPTION OF THE DRAWINGS

The description refers to the accompanying drawings in which like reference characters refer to like parts throughout the several views, and in which:

FIG. 1 is an exploded perspective view of a mounting apparatus illustrating the preferred embodiment of the invention;

FIG. 2 is an assembled view showing the saw blade mounted on a spindle;

FIG. 3 is a view as seen from the right side of FIG. 2;

FIG. 4 is a view as seen along lines 4-4 of FIG. 3;

FIG. 5 is a view of the spindle;

FIG. 6 is a perspective view of the inner washer;

FIG. 7 is another view of the inner washer;

FIG. 8 is a sectional view as seen along lines 8-8 of FIG. 7;

FIG. 9 is another view of the inner washer;

FIG. 10 is a plan view of the outer washer; and

FIG. 11 is a view of the outer washer as seen along lines 11-11 of FIG. 10.

### DESCRIPTION OF THE PREFERRED EMBODIMENT

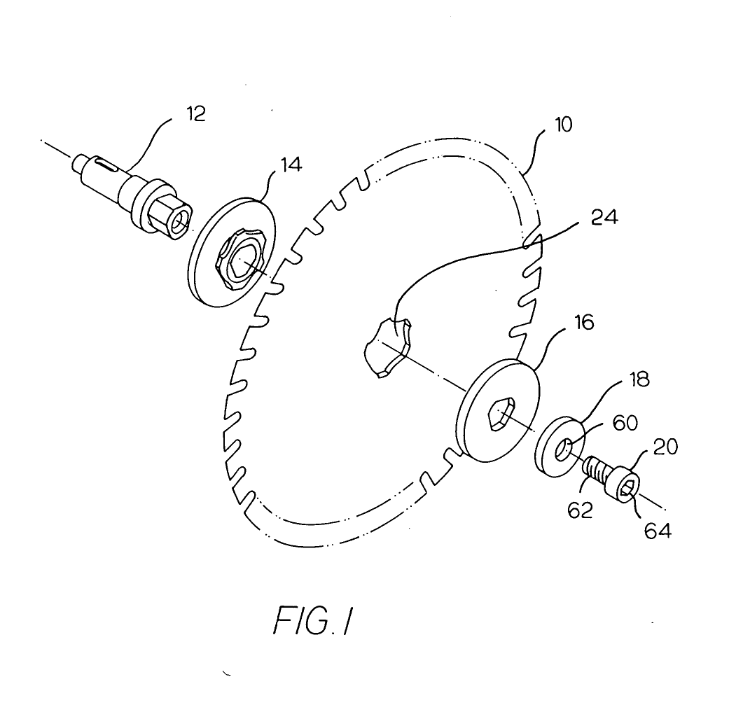

Referring to the drawings, FIG. 1 illustrates a preferred circular saw mounting arrangement which includes a circular saw blade 10, a spindle 12, and inner washer 14, an outer washer 16, a flat washer 18 and a threaded fastener 20. Referring to FIG. 3, saw blade 10 has a circular array of cutting teeth 22. The cutting teeth 22 are non-symmetrical, the cutting edges facing such that the saw blade must be rotated in the direction of arrow 23. The saw blade also has a central opening 24 as best shown in FIG. 1.

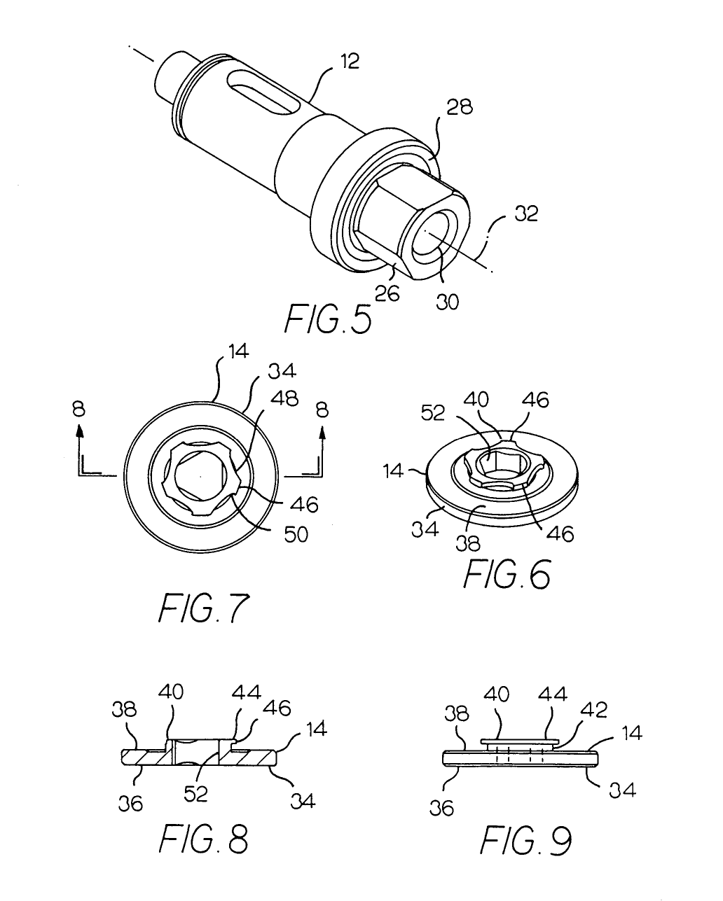

Referring to FIGS. 1 and 5, spindle 12 is adapted to be connected to a suitable driving motor, not shown. Spindle 12 has an outer six sided mounting surface 26, with three flat sides and three rounded sides, and a shoulder 28. The spindle also has an axial threaded fastener receiving opening 30 formed along the axis of rotation 32 of the spindle.

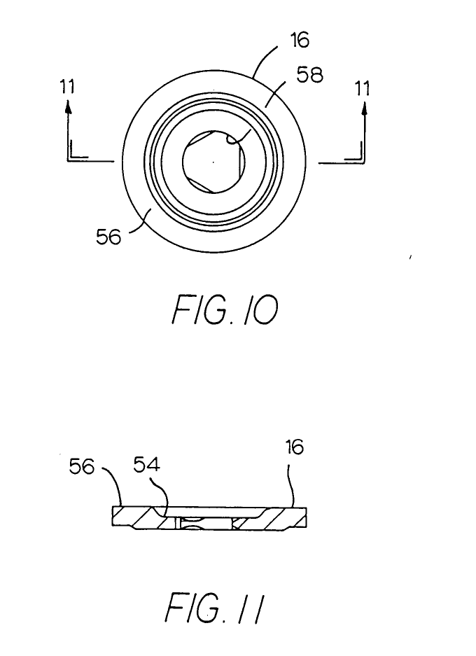

Referring to FIGS. 6-9, inner washer 14 has a circular body 34 which includes an inner surface 36 that abuts shoulder 28 of the spindle, and an outer flat saw blade clamping surface 38. The outer clamping surface 38 has a planar configuration. The inner washer has a boss 40. Boss 40 includes an inner cylindrical connecting section 42 which connects the main body of the washer to an outer flange 44.

Flange 44 has five teeth 46. The teeth are asymmetrically formed as best illustrated in FIGS. 6 and 7, that is each tooth has a long inclined side 48 and a shorter inclined side 50. The teeth are evenly spaced around the periphery of the flange. The inner washer also has a central bore 52 formed with a complementary shape to that of mounting surface 26 on the spindle so that the inner washer can be slid onto the spindle to a position abutting shoulder 28. In this position, the inner washer rotates with the spindle.

The axial thickness of cylindrical connecting section 42 is greater than the thickness of the saw blade so that when the saw blade abuts clamping surface 38, the blade is disposed entirely inside of flange 44.

Referring again to FIG. 1, opening 24 in the saw blade is configured complementary to the shape of flange 44 in such a manner that the central opening of the saw blade can be slid in an axial direction past the flange to a clamping position. The asymmetrical shape of teeth 46 on the flange provides that the backside of the blade in FIG. 1, is always mounted in abutment with clamping surface 38 because if the saw blade is reversed, the central opening will not pass over mounting flange 44.

Referring to FIGS. 10 and 11, outer washer 16 also has a circular configuration with an outer diameter greater than that of the central opening of the saw blade generally. Washer 16 has a dished portion 54 and a clamping surface 56 which is mounted in opposition to clamping surface 38 of the inner washer. Dished portion 54 is formed with a diameter greater than that of flange 44 so that the inner washer can be mounted over the flange 44 to permit clamping surface 56 to engage the saw blade at such time as the clamping surface 38 engages the opposite side of the saw blade.

The outer washer also has a central opening 58 which is complementary to the mounting surface 26 of the spindle so that the outer washer can be axially slid onto the end of the spindle. Thus both the inner washer and the outer washer rotate with the spindle.

Flat washer 18 is a standard metal washer having a central opening 60 which permits it to be mounted on the end of the spindle. Washer 18 has a sufficient diameter to provide an adequate gripping surface with the outer washer.

Still referring to FIG. 1, fastener 20 has a threaded end 62 and a hex head 64 which permits the fastener to be screwed into the tapped fastener receiving opening 30 of the spindle to a position in which the head abuts washer 18.

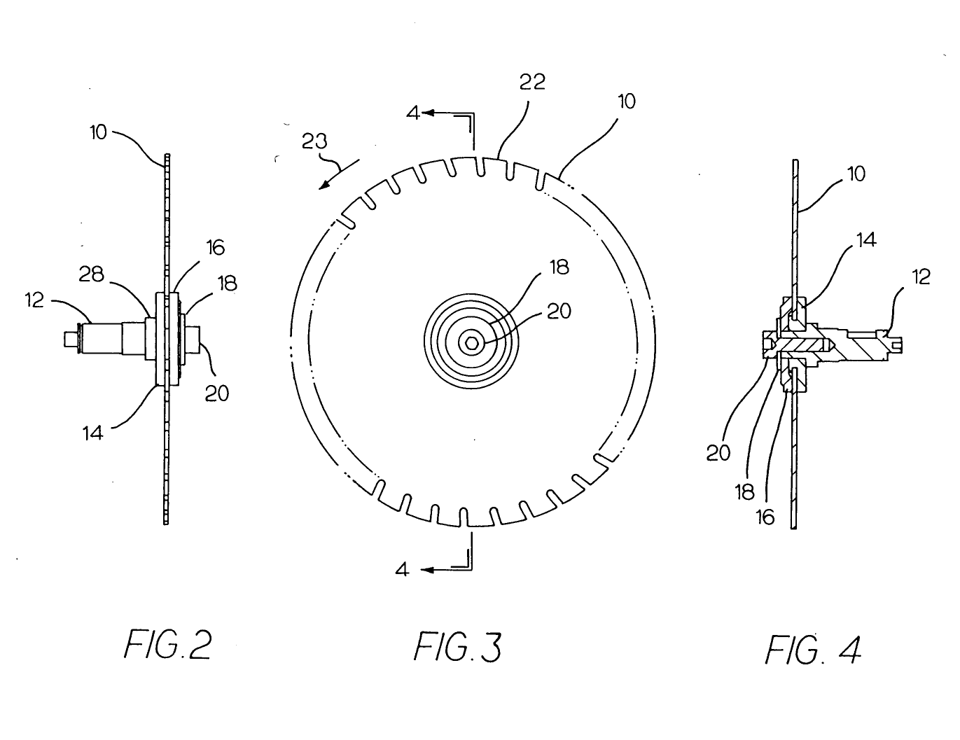

Referring to FIGS. 2 and 4, the inner washer 14 is mounted on the end of the spindle in abutment with shoulder 28. The saw blade is then passed over flange 44 of the inner washer to a position in abutment with the clamping surface of the inner washer. Outer washer 16 is then mounted on the end of the spindle with its clamping surface engaging the saw blade. The flat washer is then mounted on the spindle in abutment with the inner washer. Fastener 20 is then mounted on the spindle to tightly clamp the saw blade between the inner washer and the outer washer. This arrangement prevents the saw blade from being mismounted on the spindle, while also permitting the saw blade to be frictionally engaged to the spindle. In the event that the saw blade encounters an obstruction that stops its rotation, the saw blade can then spin loose while not damaging the driving mechanism.

1. A combination, comprising:
a spindle adapted to be rotated about an axis of rotation;
an inner washer member having a central opening mounted on the spindle so as to be rotatable therewith, the inner washer member having an annular saw blade clamping surface about said central opening, and a nonsymmetrical annular flange formed about said central opening;
structure rigidly connecting the clamping surface on the inner washer member to said flange in an axially spaced position, said connecting structure having a lesser diameter than the diameter of the saw blade member central opening whereby the saw blade member may be rotated about said connecting structure;
a saw blade member having a nonsymmetrical central opening formed with a contour complementary to the flange the inner washer so the saw blade member may be axially passed over the flange of the inner washer to a position freely rotatable about the connecting structure, the saw blade having a blade structure mounted for rotation on the spindle in a selected direction;
an outer washer having a central opening keyed to the spindle so as to be rotatable therewith, the outer washer having an annular saw blade clamping surface opposed to the saw blade clamping surface of the inner washer; and
a nut threadably mounted on the spindle for urging the outer washer toward the inner washer to clamp the saw blade therebetween whereby the saw blade is then rotatable with the spindle in a direction depending upon the cutting edge of the saw blade teeth.

2. A combination as defined in claim 1, in which the flange on the inner washer has a plurality of radially extending teeth.

3. A combination as defined in claim 2, in which said radially extending teeth overlap portions of the central opening of the saw blade member.

4, A combination as defined in claim 1, in which the outer washer has an annular clamping portion surrounding the flange of the inner washer when the saw blade is in a clamped position.
